(19) United States
(12) Patent Application Publication
(10) Pub. No.: US 2025/0377801 A1
(43) Pub. Date: Dec. 11, 2025

(54) DATA FLUSH FOR FORCE UNIT ACCESS COMMANDS

(71) Applicant: Micron Technology, Inc., Boise, ID (US)

(72) Inventors: Quan Que, Shanghai (CN); Feng Xu, Shanghai (CN); Xiaolai Zhu, Shanghai (CN); Lei Cui, Shanghai (CN)

(21) Appl. No.: 19/221,955

(22) Filed: May 29, 2025

Related U.S. Application Data
(60) Provisional application No. 63/658,331, filed on Jun. 10, 2024.

(51) Int. Cl. G06F 3/06

(52) U.S. Cl. CPC G06F 3/0613; G06F 3/0634; G06F 3/0659; G06F 3/0673

(57) ABSTRACT

Methods, systems, and devices for improved data flush for force unit access (FUA) commands are described. The described techniques provide for a memory system to determine whether to consolidate commands and flush data in accordance with the commands. In some examples, the memory system may evaluate whether a quantity of FUA write commands satisfies a threshold. If the quantity of FUA write commands satisfies the threshold, the memory system may write and flush data associated with the quantity of FUA write commands to a plurality of dies of a memory array of the memory system in accordance with a sequential write mode, a jump write mode, or both. If the quantity of FUA write commands does not satisfy the threshold, the memory system may evaluate other quantities of commands to determine whether to flush the data. The memory system may conditionally flush the data to execute the commands more efficiently.

### CROSS REFERENCE

The present Application for Patent claims priority to U.S. Patent Application No. 63/658,331 by Que et al., entitled “IMPROVED DATA FLUSH FOR FORCE UNIT ACCESS COMMANDS,” filed Jun. 10, 2024, which is assigned to the assignee hereof, and which is expressly incorporated by reference in its entirety herein.

### TECHNICAL FIELD

The following relates to one or more systems for memory, including improved data flush for force unit access commands.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not- or (NOR) and not- and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states when disconnected from an external power source.

### BRIEF DESCRIPTION OF THE DRAWINGS

FIG. 1 shows an example of a system that supports improved data flush for force unit access commands in accordance with examples as disclosed herein.

FIG. 2 shows an example of a process that supports improved data flush for force unit access commands in accordance with examples as disclosed herein.

FIG. 3 shows an example of a memory block diagram that supports improved data flush for force unit access commands in accordance with examples as disclosed herein.

FIG. 4 shows a block diagram of a memory system that supports improved data flush for force unit access commands in accordance with examples as disclosed herein.

FIG. 5 shows a flowchart illustrating a method or methods that support improved data flush for force unit access commands in accordance with examples as disclosed herein.

### DETAILED DESCRIPTION

A memory system may execute write commands received from a host device to write data to the memory system. The write commands may include force unit access (FUA) write commands. To perform a FUA operation, a memory system may bypass a cache and write directly to a memory array (e.g., a storage location, such as a not-AND (NAND) memory array, or some other memory array) of the memory system. That is, to execute a FUA write command, the memory system may flush write data directly to the memory array in response to the command. The memory system may flush data to the memory array for each received FUA command (e.g., directly in response to or based on each FUA command), which may introduce latency between execution of FUA write commands. For example, the memory system may write data associated with FUA write commands to sequential pages of a memory array. In such examples, before flushing a given page of the data, the memory system may wait for a preceding page to be flushed. However, because the memory system may wait to flush a later page of the data until all preceding pages have been flushed, latency may be increased, in some examples. Additionally, or alternatively, an FUA command may indicate a subset of data that may not fill a full page in the memory array. In such examples, the memory system may flush the subset of data and pad a remainder of the page with dummy data, which may reduce throughput of the write operations associated with the FUA write commands.

Techniques described herein provide for a memory system to conditionally flush data to a memory array in response to an FUA command. For example, instead of flushing data for each FUA command automatically, the memory system may perform one or more checks (e.g., may compare one or more quantities of commands, such as command counts) to determine whether to flush the data to the memory array in accordance with the FUA write command or whether to wait for one or more additional commands before flushing the data. In some examples, the memory system may determine whether to consolidate (e.g., merge) multiple FUA write commands into one operation. For example, the memory system may evaluate whether a quantity of FUA write commands at the memory system is greater than or equal to a first threshold. If the quantity of FUA write commands is greater than or equal to the first threshold, the memory system may write and flush data associated with the quantity of FUA write commands to one or more memory arrays across one or more memory dies of the memory system. If the quantity of FUA write commands is less than the threshold, the memory system may compare one or more other command counts, including a quantity of active commands at the memory system, a quantity of commands associated with a previous flush at the memory device, or both, to determine whether to flush data to the one or more memory arrays.

In addition to applicability in memory systems as described herein, techniques for improved data flush using FUA commands may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by improving memory access speeds and throughput, which may decrease processing or latency times, improve response times, improve write efficiency, or otherwise improve user experience, among other benefits.

Features of the disclosure are illustrated and described in the context of systems, devices, and circuits. Features of the disclosure are further illustrated and described in the context of processes, memory block diagrams, and flowcharts.

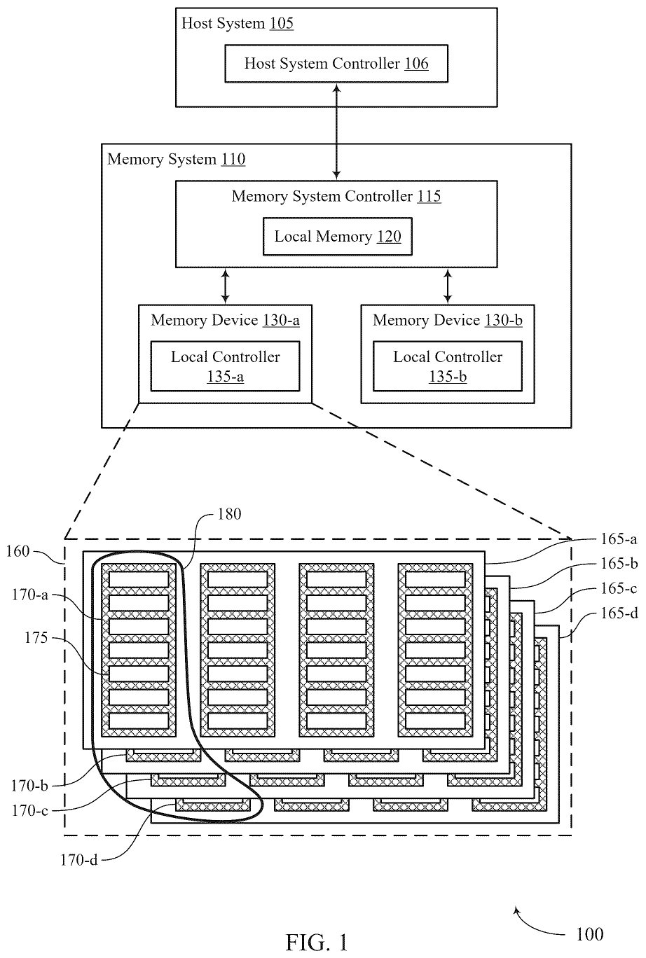

FIG. 1 shows an example of a system 100 that supports improved data flush for FUA commands in accordance with examples as disclosed herein. The system 100 includes a host system 105 coupled with a memory system 110. The system 100 may be included in a computing device such as a desktop computer, a laptop computer, a network server, a mobile device, a vehicle, an Internet of Things (IoT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations—which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., LBAs) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally, or alternatively, rely on an external controller (e.g., implemented by the host system 105) or one or more local controllers 135, which may be internal to memory devices 130, respectively, to perform the functions ascribed herein to the memory system controller 115. In general, one or more functions ascribed herein to the memory system controller 115 may, in some cases, be performed instead by the host system 105, a local controller 135, or any combination thereof. In some cases, a memory device 130 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on the same die, within the same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170 and, in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in the same page 175 may share (e.g., be coupled with) a common word line, and memory cells in the same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

In some examples, a memory device 130 may receive multiple write commands from the host system 105. The memory system (e.g., the memory system 110, the memory system controller 115) may add (e.g., store) each write command to a command queue, such as a write all bank (WAB) queue, before executing the write commands. The memory device 130 may receive multiple types of write commands from the host system 105, including write commands and FUA write commands. To write data to the memory device 130 in accordance with a write command, the memory system controller 115 may write data to the local memory 120 (e.g., a ROM, a RAM) before writing the data (e.g., flushing the data) to a non-volatile memory component of the memory device 130 (e.g., NAND). Additionally, or alternatively, the memory system controller 115 may write the data to a cache or some other location in the memory system 110 before writing the data to the memory device 130 (e.g., one or more memory arrays).

However, if executing a FUA write command, the memory system 110 may not write data to the local memory 120 or cache and may instead write the data directly to the storage location of the memory device 130. In some implementations, the memory system 110 may execute a FUA write after (e.g., immediately after, soon after, directly in response to, or the like) receiving the FUA write command. In such implementations, the memory system 110 may perform a data flush operation to flush data to the storage location in one or more memory devices 130 for every received FUA write command. During the data flush operation, the memory system controller 115 may write data across one or more dies 160 (e.g., memory dies). For example, the memory system controller 115 may write data across one or more pages 175 of one or more dies 160.

In some examples, the memory system controller 115 may sequentially write data across one or more consecutive pages of a die 160. In such examples, the memory system controller 115 may sequentially write data starting at a first page 175 of the die 160 (e.g., a sequential write mode). If the data does not fill a page 175 of the die 160, the memory system controller 115 may pad (e.g., fill) the remainder of the page 175 with dummy data (e.g., null data). For example, a FUA write command may have a size of 4 kilobytes (KBs), but the memory system controller 115 may flush pages 175 with a size of 16 KB. Accordingly, the memory system controller 115 may fill the remaining 12 KB of space on the page 175 with dummy data.

However, performing sequential write operations to execute FUA write commands may introduce latency or may otherwise be associated with reduced or relatively inefficient data throughput. In some examples, data to be written sequentially across multiple consecutive pages 175 may be flushed sequentially. In such examples, the memory system controller 115 may flush a first page containing first data to the memory array. The memory system controller 115 may wait for the first page to flush to the memory array before flushing a second page containing second data to the memory array. As such, as multiple FUA commands are issued and additional data is flushed sequentially in response to the FUA commands, the flush of some data to later pages in the memory array may be blocked by the flush of data to earlier pages in the memory array. Accordingly, commands associated with (e.g., stored to) later pages 175 of a die 160 may be held in the command queue for a longer duration relative to commands associated with earlier pages 175 of the die 160, which may increase latency associated with FUA writes.

As described herein, to reduce latency associated with executing FUA write commands, a memory system 110 may conditionally flush data to a memory array of the memory system in response to receiving one or more FUA write commands. In some examples, the memory system controller 115 may consolidate (e.g., merge) multiple FUA write commands in accordance with performing one or more command count comparisons relative to one or more respective thresholds. For example, the memory system controller 115 may evaluate whether a quantity of FUA write commands at the memory system 110 is greater than or equal to a first threshold. If the memory system controller 115 determines that the quantity of FUA write commands is greater than or equal to the first threshold, the memory system controller 115 may flush data associated with the FUA write commands to one or more dies 160 of the memory system 110. For example, if each FUA write command has a size of 4 KB and if the memory system controller 115 flushes pages 175 with a size of 16 KB, the first threshold may be four. In such examples, the memory system controller 115 may merge four 4 KB FUA write commands such that the total size of data to be flushed in response to the merged commands satisfies the 16 KB of space to flush the page 175 without padding the page 175 with dummy data.

If the memory system controller 115 determines that the quantity of FUA write commands is less than the first threshold, the memory system controller 115 may perform one or more additional command count comparisons to determine whether to flush the data associated with the FUA write commands. For example, the memory system controller 115 may determine whether a quantity of active commands at the memory system 110 is greater than a second threshold. The second threshold may be the same as or different than the first threshold. If the memory system controller 115 determines that the quantity of active commands is greater than the second threshold, the memory system controller 115 may set a wait time for the memory system 110. The memory system 110 may wait for the active commands to finish execution in accordance with the wait time. In some examples, the wait time may be equal to 500 microseconds, or some other duration. After the wait time has elapsed, the memory system controller 115 may evaluate a status of commands at the memory system 110, including determining whether the quantity of FUA write commands is greater than or equal to the first threshold again.

If the memory system controller 115 determines that the quantity of active commands is less than or equal to the second threshold, the memory system controller 115 may determine whether a sum of the quantity of FUA write commands and the quantity of active commands is less than or equal to a third threshold. In some examples, the third threshold may be the same as the first threshold, the second threshold, or both. In some other examples, the third threshold may be different from the first threshold, the second threshold, or both. If the memory system controller 115 determines that the quantity of active commands is less than or equal to the third threshold, the memory system controller 115 may set a wait time for the memory system 110. The memory system 110 may wait for the active commands to finish execution in accordance with the wait time. In some examples, the wait time may be equal to 500 microseconds, or some other duration. After the wait time has elapsed, the memory system controller 115 may evaluate a status of commands at the memory system 110, including determining whether the quantity of FUA write commands is greater than or equal to the first threshold again.

If the memory system controller 115 determines that the sum of the quantity of FUA write commands and the quantity of active commands is greater than the third threshold, the memory system controller 115 may determine whether the quantity of FUA write commands is greater than or equal to a quantity of commands associated with a previous data flush operation by the memory system 110. If the memory system controller 115 determines that the quantity of FUA write commands is less than the quantity of commands associated with the previous data flush operation, the memory system controller 115 may set a wait time for the memory system 110. The memory system 110 may wait for additional FUA write commands in accordance with the wait time. In some examples, the wait time may be equal to 20 microseconds, or some other duration. If the memory system controller 115 determines that the quantity of FUA write commands is greater than or equal to the quantity of commands associated with the previous data flush operation, the memory system controller 115 may set a null or otherwise minimal wait time for the memory system 110, which may be equal to zero microseconds, or some other duration.

After the wait time has elapsed, the memory system controller 115 may check for a timeout event at the memory system 110. In some examples, the timeout event may be associated with an absence of received write commands from the host system 105. If the memory system controller 115 determines that a timeout event has not occurred, the memory system controller 115 may evaluate a status of commands at the memory system 110, including determining whether the quantity of FUA write commands is greater than or equal to the first threshold. If the memory system controller 115 determines that the timeout event has occurred, the memory system controller 115 may initiate a data flush operation. In some examples, the memory system controller 115 may calculate a quantity of process commands to perform. In such examples, the process commands may be FUA write commands, and the quantity of process commands may be equal to the quantity of FUA write commands or may be different from (e.g., greater than, less than) the quantity of FUA write commands. For example, the memory system controller 115 may perform up to four process commands in accordance with the size of the FUA write command and the size associated with flushing pages 175, or some other quantity of process commands.

After calculating the quantity of process commands, the memory system controller 115 may write and flush data to the one or more memory arrays of the one or more memory devices 130 in accordance with the process commands. For example, the memory system controller 115 may allocate data for a sequence of writes (SOW) (e.g., a sequence of write operations) associated with the process commands. The memory system controller 115 may insert data associated with the SOW and may flush the data to the memory array. After successful completion of the data flush operation, the memory system 110 may send a response to the host system 105 indicating completion of the data flush operation and execution of the FUA write commands.

As a part of the data flush operation, the memory system controller 115 may write data across non-consecutive pages 175 of multiple dies 160. The memory system controller 115 may write the data in accordance with a FUA write type (e.g., a jump write mode). In the jump write mode, the memory system controller may write to a first pageline of a first die 160, then may write to the first pageline of a second die 160 before filling the first pageline of the first die 160. That is, the memory system controller 115 may uniformly distribute data associated with FUA write commands across multiple dies 160.

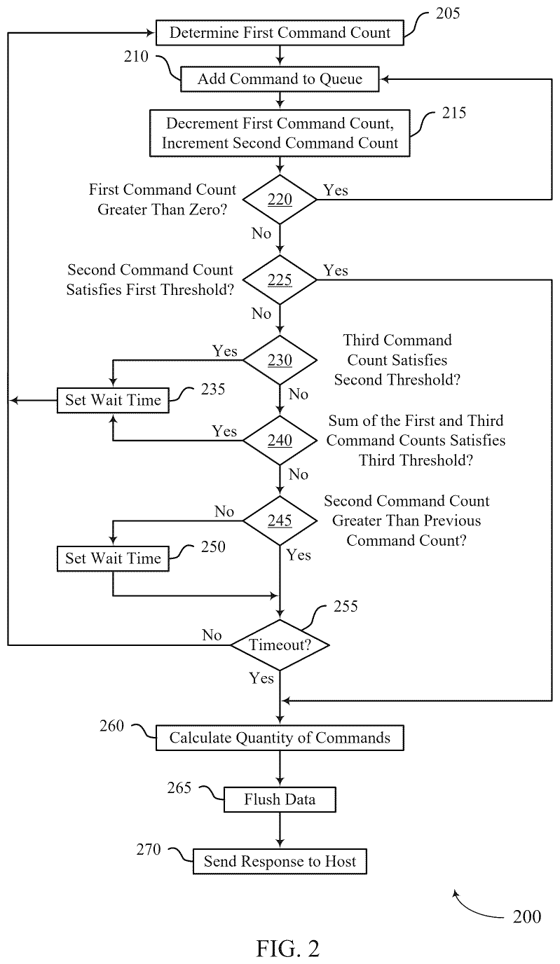

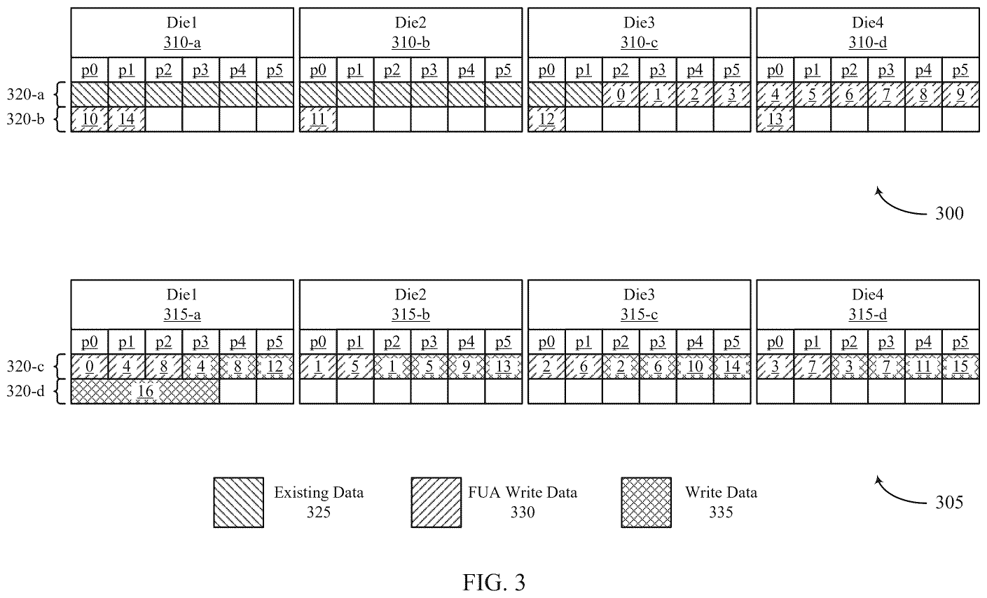

The memory system controller 115 may consolidate the FUA write commands to reduce a frequency of data flush operations at the memory system 110 and to eliminate dummy data padded to the pages 175 of the memory device 130. Additionally, or alternatively, the memory system 110 may implement the jump write mode to distribute FUA write commands across one or more dies 160 of the memory system 110 to mitigate latency associated with flushing sequentially written data. Example write types and patterns may be described in further detail elsewhere herein, including with reference to FIGS. 2 and 3.

The system 100 may include any quantity of non-transitory computer readable media that support improved data flush for FUA commands. For example, the host system 105 (e.g., a host system controller 106), the memory system 110 (e.g., a memory system controller 115), or a memory device 130 (e.g., a local controller 135), or any combination thereof may include or otherwise may access one or more non-transitory computer readable media storing instructions (e.g., firmware, logic, code) for performing the functions ascribed herein to the host system 105, the memory system 110, or the memory device 130, or combination thereof. For example, such instructions, if executed by the host system 105 (e.g., by a host system controller 106), by the memory system 110 (e.g., by a memory system controller 115), or by a memory device 130 (e.g., by a local controller 135), may cause the host system 105, the memory system 110, or the memory device 130 to perform associated functions as described herein.

FIG. 2 shows an example of a process 200 that supports improved data flush for FUA commands in accordance with examples as disclosed herein. The process 200 may implement, or be implemented by, one or more aspects of the system 100. For example, the process 200 may illustrate operations performed by a memory system, which may be an example of a memory system 110 described with reference to FIG. 1. In some examples, the process 200 may support the memory system determining whether to perform a data flush. Alternative examples may be implemented, where some processes are performed in a different order than described or are not performed. In some cases, processes may include additional features not mentioned below, or further processes may be added.

Aspects of the process 200 may be implemented by one or more controllers, among other components. Additionally, or alternatively, aspects of the process 200 may be implemented as instructions stored in one or more memories (e.g., firmware stored in one or more memories coupled with the memory system). For example, the instructions, if executed by one or more controllers (e.g., the memory system controller 115, the local controller 135 as described with reference to FIG. 1), may cause the one or more controllers (or a device or system) to perform the operations of the process 200.

At 205, a first command count may be determined. In some examples, a memory system (e.g., the memory system 110 or a memory system controller 115) may count a first quantity of commands (e.g., access commands) as they are received, executed, or both, and may update the first command count accordingly. For example, the memory system controller 115 may determine a first command count associated with the first quantity of commands. The first command count and the first quantity of commands may be associated with a first type of command, which may be a write command (e.g., a non-FUA command).

At 210, a first command may be added to a command queue. In some examples, the memory system controller 115 may add the first command to the command queue. For example, the memory system controller 115 may add the first command to the command queue in response to (e.g., in direct response to, based on) receiving the first command from the host system 105. In some examples, the command queue may be an example of a buffer (e.g., a buffer memory), such as a WAB queue, or some other type of queue. Adding the command to the command queue may place the command in position for execution by the memory system controller 115.

At 215, the first command count may be decremented, and a second command count may be incremented in response to (e.g., in direct response to, based on) the first command being received and added to the command queue. In some examples, the memory system controller 115 may decrement the first command count and increment a second command count associated with a second quantity of commands different from the first quantity of commands. In some examples, the second command count and the second quantity of commands may be associated with a second type of command different from the first type of command, which may be a FUA write command. In some examples, a write operation of the second type may be executed in response to the first command being added to the command queue, and some set of data may be written to a cache or a memory array in the memory system 110. The first command count (e.g., hardware command count) may be decremented in response to the write operation being executed.

At 220, it may be determined whether the first command count is greater than a default threshold (e.g., zero, or some other quantity). In some examples, the memory system controller 115 may determine whether the first command count is greater than the default threshold. If the first command count is greater than the default threshold, another first command may be added to the command queue. For example, the process 200 may return to 210, and the memory system controller 115 may add an additional first command to the command queue for subsequent execution. In some examples, the additional first command may be one of the first quantity of commands associated with the first command count.

If the first command count is less than or equal to the default threshold (e.g., is equal to zero), at 225, it may be determined whether the second command count satisfies a first threshold. In some examples, the memory system controller 115 may determine whether the second command count satisfies the first threshold. For example, the memory system controller 115 may compare the second command count to a first threshold to determine whether the second command count is greater than or equal to the first threshold quantity. The first threshold may be predetermined, may be configured at the memory system 110, or both. For example, the first threshold may be equal to four, or some other quantity, and the memory system controller 115 may determine whether the quantity of second commands is greater than or equal to four. The value of the first threshold may be in accordance with (e.g., at least partially based on, defined in accordance with) a page size of one or more memory devices 130 in the memory system 110, a write size, an FUA write size, or any combination thereof. For example, if the FUA write size is 4 KB and a page size is 16 KB, the first threshold may be equal to four in response to the page size including four FUA write sizes. If the second command count satisfies the first threshold (e.g., is greater than or equal to the first threshold), the memory system controller 115 may initiate a data flush operation. For example, the process 200 may jump to 260 and a third quantity of commands may be calculated. In some examples, the memory system controller 115 may calculate the third quantity of commands, which may be associated with one or more FUA write commands to be executed by the memory system controller 115.

If the second command count does not satisfy the first threshold (e.g., is less than the first threshold), the memory system controller 115 may perform one or more command count comparisons. For example, at 230, it may be determined whether a third command count satisfies a second threshold. In some examples, the memory system controller 115 may determine whether the third command count satisfies the second threshold. For example, the memory system controller 115 may determine whether the third command count is greater than a second threshold value. The third command count may be associated with a quantity of active (e.g., ongoing) write operations at the memory system 110 (e.g., a programming command count). The second threshold value may be predetermined, may be configured at the memory system 110, or both. For example, the second threshold may be equal to four, and the memory system controller 115 may determine whether a quantity of write commands currently being executed by the memory system controller 115 is greater than four, or some other quantity. In some examples, the first threshold value and the second threshold may be equal. Alternatively, the first threshold value and the second threshold may be different.

At 235, if the third command count satisfies the second threshold (e.g., is greater than the second threshold), a wait time may be set. In some examples, the memory system controller 115 may set the wait time. For example, the memory system controller 115 may set the wait time in accordance with a first delay value in response to determining that the third command count satisfies the second threshold. In some cases, the first delay value may be predetermined. For example, the first delay value may be equal to 500 microseconds, and the memory system controller 115 may set the wait time to 500 microseconds in response to determining that the third command count is greater than the second threshold, or the first delay value may be some other value. After setting the wait time at 235 in response to determining that the third command count satisfies the second threshold, the process 200 may return to 205, and the memory system controller 115 may determine the first command count again.

At 240, if the third command count does not satisfy the second threshold, it may be determined whether a sum of the first command count and the third command count (e.g., a sum of the programming command count and the FUA command count) satisfy a third threshold. In some examples, the memory system controller 115 may determine whether the sum satisfies the third threshold. For example, the memory system controller 115 may determine whether the sum is less than or equal to a third threshold value. The third threshold value may be predetermined, may be configured at the memory system 110, or both. For example, the third threshold value may be equal to four, and the memory system controller 115 may determine whether the sum is less than or equal to four, or some other value. In some examples, the first threshold value, the second threshold value, the third threshold value, or any combination thereof, may be equal. Alternatively, the first threshold value, the second threshold value, the third threshold value, or any combination thereof, may be different.

If the sum of the first command count and the third command count satisfies the third threshold (e.g., is less than or equal to the third threshold), at 235, a wait time may be set. In some examples, the memory system controller 115 may set the wait time. For example, the memory system controller 115 may set the wait time in accordance with a first delay value in response to determining that the sum satisfies the third threshold. In some cases, the first delay value may be configured. For example, the first delay value may be equal to 500 microseconds, and the memory system controller 115 may set the wait time to 500 microseconds in response to determining that the sum is less than or equal to the third threshold, or the first delay value may be some other value. After setting the wait time at 235 in response to determining that the sum of the first command count and the third command count satisfies the third threshold, the process 200 may return to 205, and the memory system controller 115 may determine the first command count again.

At 245, if the sum of the first command count and the third command count does not satisfy the third threshold (e.g., is greater than the third threshold), it may be determined whether the second command count is greater than or equal to a previous command count. In some examples, the memory system controller 115 may determine whether the second command count is greater than or equal to the previous command count. The previous command count may be associated with a quantity of commands associated with a previously-performed memory flush operation. For example, the previous command count may represent a quantity of commands associated with a most-recent memory flush operation performed by the memory system controller 115.

At 250, if the second command count is not greater than or equal to the previous command count, a wait time may be set. In some examples, the memory system controller 115 may set the wait time. For example, the memory system controller 115 may set the wait time in accordance with a second delay value in response to determining that the second command count is not greater than or equal to the previous command count. In some cases, the second delay value may be predetermined. For example, the second delay value may be equal to 20, and the memory system controller 115 may set the wait time to 20 microseconds in response to determining that the second command count is not greater than the previous command count. The second delay value may additionally, or alternatively, be equal to any other value in response to one or more parameters or characteristics associated with the memory system 110.

If the second command count is greater than or equal to the previous command count, a wait time may be set. In some examples, the memory system controller 115 may set the wait time. For example, the memory system controller 115 may set the wait time in accordance with a third delay value in response to determining that the second command count is greater than or equal to the previous command count. In some cases, the third delay value may be zero or some other relatively small value. For example, the first delay value may be equal to zero, and the memory system controller 115 may set the wait time to zero microseconds in response to determining that the second command count is greater than or equal to the previous command count.

At 255, it may be determined whether a timeout occurs. For example, the memory system controller 115 may determine whether the memory system 110 experiences a timeout event. In some examples, the memory system 110 may experience the timeout event in response to determining whether the one or more command count comparisons is completed within a threshold duration. For example, the memory system controller 115 may initiate the command count comparisons at a first time, and may determine whether a second time at which the command count comparisons are complete is within the threshold duration. In some cases, the threshold duration may be equal to the wait time (e.g., 20 microseconds, zero microseconds). In some other examples, the memory system 110 may experience the timeout event if there is an absence of write commands received from a host system 105. That is, the memory system 110 may not receive write commands from the host system 105 over a duration, which may cause the memory system controller 115 to declare a timeout event. If the memory system 110 does not experience the timeout event, the memory system controller 115 may determine the first command count again. For example, the process 200 may return to 205, and the memory system controller 115 may determine the first command count.

At 260, if the memory system 110 experiences the timeout event, or if the second command count satisfies the first threshold at 225, a third quantity of commands may be calculated. In some examples, the memory system controller 115 may calculate the third quantity of commands, which may be associated with one or more FUA write commands to be executed by the memory system controller 115. For example, if the memory system 110 experiences a timeout event, or if the second command count satisfies the first threshold, the memory system controller 115 may perform a data flush operation. As a part of the data flush operation, the memory system controller 115 may determine the third quantity of commands. In some examples, the third quantity of commands may be less than or equal to the first threshold value. That is, the third quantity of commands may be less than or equal to four. In some examples, the third quantity of commands may include the second quantity of commands. That is, the third quantity of commands may include up to four FUA write commands.

At 265, a data flush may occur. In some examples, the memory system controller 115 may perform a data flush operation. For example, the memory system controller 115 may flush data associated with the third quantity of commands to a memory array of one or more memory devices 130. The data flush operation may include allocating space for a SOW, inserting data associated with the SOW, and flushing the data associated with the SOW to the NAND of the memory device 130.

At 270, a response may be sent to the host system 105. In some examples, the memory system controller 115 may send the response to the host system 105. For example, the memory system controller 115 may send the response to the host system 105 indicating that the data flush operation was performed.

Such techniques may reduce a frequency of data flushes of the memory system 110 performed to execute FUA write commands, which may improve the overall performance of the memory system 110. That is, by performing the operations of the process 200, the memory system 110 may more selectively flush data to the memory arrays of the one or more memory devices 130 in response to comparing one or more command counts at the memory system 110, which may support more efficient data flushes, reduced latency, and improved data throughput for the memory system 110.

FIG. 3 shows an example of a first write configuration 300 and a second write configuration 305 that support improved data flush for FUA commands in accordance with examples as disclosed herein. In some examples, a memory system (e.g., the memory system 110, the memory system controller 115 as described with reference to FIG. 1) may perform write operations associated with write commands received from a host system (e.g., a host system 105 as described with reference to FIG. 1). For example, the memory system controller 115 may write data to one or more dies 310 (e.g., memory dies) of the memory system 110, including a first die 310-a, a second die 310-b, a third die 310-c, and a fourth die 310-d, in accordance with the first write configuration 300, may write data to one or more dies 315 of the memory system 110, including a first die 315-a, a second die 315-b, a third die 315-c, and a fourth die 315-d, in accordance with the second write configuration 305, or both. In some examples, the first write configuration 300 may be associated with a first write mode, such as a sequential write mode, and the second write configuration 305 may be associated with a second write mode, such as a FUA write mode. In the example of FIG. 3, the first write mode may be associated with writing data to sequential planes of the one or more dies 310 of the memory system 110, and the second write mode may be associated with writing data to non-consecutive planes of the one or more dies 310 of the memory system 110.

Each die 310 may include at least a first pageline 320-a and a second pageline 320-b. Similarly, each die 315 may include at least a first pageline 320-c and a second pageline 320-d. Each pageline 320 may span a plurality of planes (e.g., a plane 165 as described with reference to FIG. 1). In the example of FIG. 3, each pageline 320 spans six planes (e.g., p0, p1, p2, p3, p4, and p5). However, it should be noted that other examples may span more or fewer planes 165 than what is depicted in the example of FIG. 3.

In some examples, some or all of the dies 310 may include existing data 325. The existing data 325 may be associated with one or more previous write operations performed by the memory system controller 115, such as a write operation associated with a first write type (e.g., a write command), a second write type (a FUA write command), or both. In some examples, the existing data 325 may be written to the dies 310 sequentially during a write operation previously performed by the memory system controller 115. The memory system controller 115 may enter (e.g., switch to) or maintain (e.g., stay in) a sequential write mode to write the existing data 325. For example, in accordance with the first write configuration 300, the memory system controller 115 may write data to a first plane 165 (e.g., p0) of the first pageline 320-a of the first die 310-a with existing data 325. After writing data to a final plane 165 (e.g., p5) of the first pageline 320-a of the first die 310-a, the memory system controller 115 may continue writing the data across the first pageline 320-a of the second die 310-b, starting with a first plane 165 of the first pageline 320-a of the second die 310-b. In the example first write configuration 300, the memory system controller 115 may finish writing existing data 325 to a middle plane 165 (e.g., p1) of the first pageline 320-a of the third die 310-c. The memory system controller 115 may not write existing data 325 to the remaining planes 165 of the first pageline 320-a of the third die 310-c and the first pageline 320-a of the fourth die 310-d. However, it should be stated that in some other examples, the memory system controller 115 may write existing data 325 across all planes 165 of the first pageline 320-a of each die 310. In such examples, the memory system controller 115 may continue to write existing data 325 starting from a first plane 165 of a second pageline 320-b of the first die 310-a.

In some examples, where the existing data 325 occupies some of (e.g., a portion of) the first pageline 320-a of the third die 310-c, the memory system controller 115 may write FUA write data 330 (e.g., data associated with a FUA write command) to the unwritten planes 165 of the third die 310-c, the fourth die 310-d, and across the second pageline 320-b. For example, the memory system controller 115 may sequentially write the FUA write data 330 across the remaining planes 165 of the first pageline 320-a. In such examples, the memory system controller 115 may maintain (e.g., stay in) a sequential write mode for the remaining planes 165 of the first pageline 320-a such that all data (e.g., existing data 325, FUA write data 330) written to the first pageline 320-a is written sequentially across the dies 310. For example, in the first write configuration 300, the FUA write data 330 is written sequentially across the remaining planes 165 of the first pageline 320-a that span the third die 310-c and the fourth die 310-d.

Upon reaching the end of the first pageline 320-a (e.g., after writing the existing data 325 to a final plane 165 of the first pageline 320-a of the fourth die 310-d), the memory system controller 115 may switch a writing mode of the memory system controller 115 from a sequential write mode to a jump write mode. If in the jump write mode, the memory system controller 115 may uniformly distribute FUA write data 330 across non-consecutive planes 165 of the second pageline 320-b. For example, the memory system controller 115 may write the FUA write data 330 to each first plane 165 (e.g., p0) of the second pageline 320-b of each die 310. After writing FUA write data 330 to each first plane 165 of the second pageline 320-b of each die 310 (e.g., after writing FUA write data 330 to the first plane 165 of the second pageline 320-b of the fourth die 310-d), the memory system controller 115 may write the FUA write data to each second plane 165 (e.g., p1) of the second pageline 320-b of each die 310.

In some other examples, some or all of the dies 315 may include FUA write data 330. The FUA write data 330 may be associated with one or more previous FUA write commands executed by the memory system controller 115. In some examples, the FUA write data 330 may be written to the dies 315 using a jump write mode in accordance with the first write configuration 300. For example, the memory system controller 115 may enter the jump write mode to write the FUA write data 330 across the first plane 165 and the second plane 165 of the first pageline 320-c of each die 315. The memory system controller 115 may finish writing the FUA write data 330 to a third plane 165 (e.g., p2) of the first pageline 320-c of the first die 315-a. After writing the FUA write data 330, the memory system controller 115 may write the write data 335 associated with additional write commands (e.g., from the host system 105). In the example of the second write configuration 305, the memory system controller 115 may already be in a jump write mode after writing the FUA write data 330. In such examples, the memory system controller 115 may maintain the jump write mode for the remaining planes 165 of the first pageline 320-c such that all data (e.g., FUA write data 330, write data 335) written to the first pageline 320-c is written non-sequentially across the dies 315. That is, the memory system controller 115 may distribute the write data 335 across each die 315 until reaching the end of the first pageline 320-c. For example, after writing the FUA write data 330 to the third plane 165 of the first pageline 320-c of the first die 315-a, the memory system controller 115 may write the write data 335 to the third plane 165 of the first pageline 320-c of the second die 315-b, the third die 315-c, and the fourth die 315-d.

The memory system controller 115 may implement the jump write mode to reduce latency associated with executing the FUA write commands. For example, the memory system controller 115 may flush a first page 175 associated with a quantity of FUA write commands. The memory system controller 115 may also flush one or more additional pages associated with the quantity of FUA write commands. In some examples, where the data is written to the dies 310 sequentially, the memory system controller 115 may wait for the first page flush to complete before flushing the one or more additional pages, which may introduce latency for each flush. However, in the example of the second write configuration 305, because the one or more additional pages are distributed across the multiple dies 310, the memory system controller 115 may flush the one or more additional pages without waiting for the first page flush to complete.

Upon reaching the end of the first pageline 320-c (e.g., after writing the write data 335 in a final plane 165 of the first pageline 320-c of the fourth die 315-d), the memory system controller 115 may switch the writing mode of the memory system controller 115 from the jump write mode to the sequential write mode. The memory system controller 115 may switch to the sequential write mode to write (e.g., finish writing) the write data 335. For example, the memory system controller 115 may write the write data 335 to one or more planes 165 of the second pageline 320-d of the first die 315-a. The memory system controller 115 may fill the second pageline 320-d of the first die 315-a before writing write data 335 to the second pageline 320-d of the second die 315-b, the third die 315-c, or the fourth die 315-d. In some examples, the memory system controller 115 may switch to the sequential write mode to write the write data 335 if the write data 335 is large (e.g., occupies multiple planes 165).

In the example of FIG. 3, the memory system 110 may be associated with (e.g., include) a quad die package (QDP). That is, the memory system 110 may include four dies 310 (e.g., the first die 310-a, the second die 310-b, the third die 310-c, and the fourth die 310-d) or four dies 315 (e.g., the first die 315-a, the second die 315-b, the third die 315-c, and the fourth die 315-d). In some other examples, the memory system 110 may include a one die package (1DP), a dual die package (DDP), or an eight die package (8DP), or any other quantity of dies. In cases where the memory system 110 includes two dies (e.g., DDP), the memory system 110 may write data to the two dies in accordance with the sequential write mode, the jump write mode, or both.

In cases where the memory system 110 includes the eight dies (e.g., 8DP), the memory system 110 may include a first set of four dies corresponding to a left half of a pageline 320 and a second set of four dies corresponding to a right half of a pageline 320. In such cases, the memory system 110 may write data to the first set of four dies in accordance with a writing mode. Once the end of the pageline 320 is reached for the first set of four dies, the memory system 110 may write data to the corresponding pageline of the second set of four dies. The memory system 110 may determine whether to switch the writing mode after reaching the end of the pageline 320. For example, the memory system 110 may write to the first set of four dies in accordance with the jump write mode and may write to the second set of four dies in accordance with the sequential write mode. Alternatively, the memory system 110 may write to both sets of dies in accordance with one of the jump write mode or the sequential write mode.

As described herein, the memory system controller 115 may implement the jump write mode to reduce latency associated with flushing pages of memory in accordance with a quantity of FUA write commands to be executed by the memory system controller. The memory system controller 115 may additionally implement the sequential write mode to write relatively large amounts of write data 335 in accordance with a quantity of write commands. By implementing both the jump write mode and the sequential write mode, the memory system controller 115 may more efficiently execute write commands received from the host system 105.

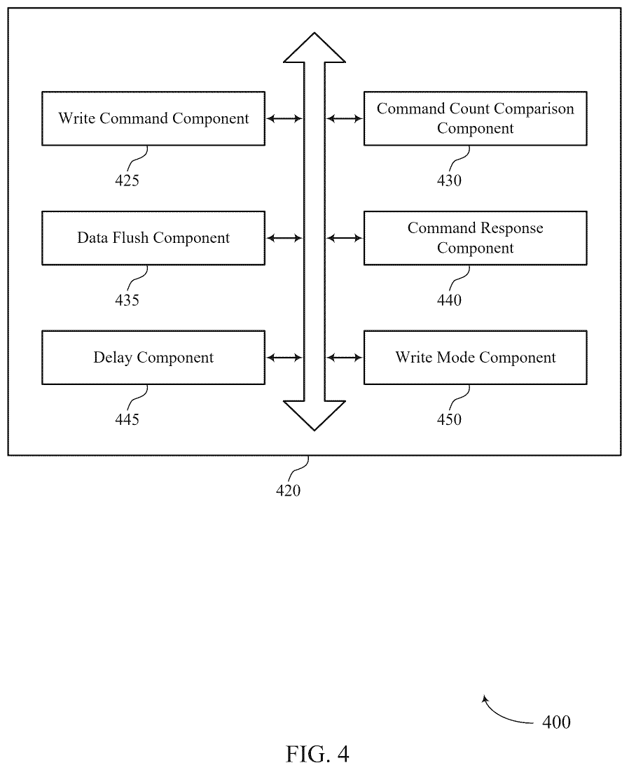

FIG. 4 shows a block diagram 400 of a memory system 420 that supports improved data flush for FUA commands in accordance with examples as disclosed herein. The memory system 420 may be an example of aspects of a memory system as described with reference to FIGS. 1 through 3. The memory system 420, or various components thereof, may be an example of means for performing various aspects of improved data flush for FUA commands as described herein. For example, the memory system 420 may include a write command component 425, a command count comparison component 430, a data flush component 435, a command response component 440, a delay component 445, a write mode component 450, or any combination thereof. Each of these components, or components of subcomponents thereof (e.g., one or more processors, one or more memories), may communicate, directly or indirectly, with one another (e.g., via one or more buses).

The write command component 425 may be configured as or otherwise support a means for executing one or more first write commands in a command queue of the memory system, the one or more first write commands associated with a first write type. The command count comparison component 430 may be configured as or otherwise support a means for comparing, in response to executing the one or more first write commands, a quantity of one or more second write commands in the command queue with a threshold quantity that is greater than one, where the one or more second write commands indicate data to write to one or more memory devices of the memory system and are associated with a second write type different than the first write type. The data flush component 435 may be configured as or otherwise support a means for determining whether to flush the data to the one or more memory devices in response to comparing the quantity of the one or more second write commands with the threshold quantity.

In some examples, the data flush component 435 may be configured as or otherwise support a means for flushing the data to the one or more memory devices in accordance with the quantity of the one or more second write commands being greater than or equal to the threshold quantity. In some examples, the command response component 440 may be configured as or otherwise support a means for transmitting, to a host system coupled with the memory system, a response in accordance with flushing the data to the one or more memory devices.

In some examples, the command count comparison component 430 may be configured as or otherwise support a means for performing, in accordance with the quantity of the one or more second write commands being less than the threshold quantity, one or more command count comparisons, where determining whether to flush the data to the one or more memory devices is further in accordance with the one or more command count comparisons.

In some examples, the command count comparison component 430 may be configured as or otherwise support a means for determining whether a second time at which performance of the one or more command count comparisons is complete is within a threshold time period of a first time at which the performance of the one or more command count comparisons is initiated. In some examples, the data flush component 435 may be configured as or otherwise support a means for flushing the data to the one or more memory devices in response to determining that the second time is not within the threshold time period.

In some examples, to support performing the one or more command count comparisons, the command count comparison component 430 may be configured as or otherwise support a means for comparing, at a first time, a second quantity of one or more pending write operations with the threshold quantity, the second quantity of one or more pending write operations including one or more write operations that are being executed by the memory system. In some examples, to support performing the one or more command count comparisons, the command count comparison component 430 may be configured as or otherwise support a means for comparing, at a second time that is after the first time, a sum of the second quantity of one or more pending write operations and the quantity of the one or more second write commands with the threshold quantity. In some examples, to support performing the one or more command count comparisons, the write command component 425 may be configured as or otherwise support a means for executing, at a third time, one or more third write commands of the first write type that are in the command queue, where executing the one or more third write commands is in accordance with the second quantity being greater than the threshold quantity or is in accordance with the sum being less than or equal to the threshold quantity or both, and where a duration between the first time and the third time includes a delay in accordance with the one or more command count comparisons.

In some examples, to support performing the one or more command count comparisons, the command count comparison component 430 may be configured as or otherwise support a means for comparing, in accordance with a second quantity of one or more pending write operations being less than the threshold quantity and in accordance with a sum of the second quantity of one or more pending write operations and the quantity of the one or more second write commands being less than or equal to the threshold quantity, the quantity of the one or more second write commands with a most recent quantity of one or more commands flushed to the one or more memory devices in a previous flush cycle of the memory system. In some examples, to support performing the one or more command count comparisons, the delay component 445 may be configured as or otherwise support a means for determining whether to generate a delay in response to comparing the quantity of the one or more second write commands with the most recent quantity of one or more commands flushed to the one or more memory devices in the previous flush cycle of the memory system.

In some examples, the delay component 445 may be configured as or otherwise support a means for generating the delay in accordance with the quantity of the one or more second write commands being less than the most recent quantity of one or more commands flushed to the one or more memory devices, where generating the delay extends a duration for performing the one or more command count comparisons.

In some examples, to support flushing the data, the write command component 425 may be configured as or otherwise support a means for writing a first portion of the data to a first plane of each memory die of a plurality of memory dies of the memory system. In some examples, to support flushing the data, the write command component 425 may be configured as or otherwise support a means for writing, after writing to the first plane in every memory die of the plurality of memory dies, a second portion of the data to a second plane of each memory die of the plurality of memory dies.

In some examples, to support flushing the data, the write command component 425 may be configured as or otherwise support a means for writing, before writing the first portion of the data to the first plane, a third portion of the data sequentially across a subset of one or more planes of one or more first memory dies of the plurality of memory dies. In some examples, to support flushing the data, the write mode component 450 may be configured as or otherwise support a means for switching from a sequential write mode to a jump write mode in response to completing a write of the third portion of the data to a final plane of a final memory die in a first page line across the plurality of memory dies, where each page line of one or more page lines of the memory system includes one or more pages of memory across each plane of each memory die of the plurality of memory dies, where the first plane includes a beginning of the one or more page lines, and where writing the first portion of the data to the first plane of each memory die is in accordance with switching to the jump write mode.

In some examples, to support flushing the data, the write mode component 450 may be configured as or otherwise support a means for switching from a jump write mode associated with writing the first portion of the data and the second portion of the data to a sequential write mode in response to completing a write of the second portion of the data to the second plane in each memory die of the plurality of memory dies, where the second plane includes a final plane of a final memory die in a page line across the plurality of memory dies.

In some examples, the threshold quantity is in accordance with a page size associated with the one or more memory devices.

In some examples, the first write type includes a non-FUA write type and the second write type includes an FUA write type.

In some examples, the described functionality of the memory system 420, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 420, or various components thereof, may be implemented at least in part by instructions (e.g., stored in memory, non-transitory computer-readable medium) executable by such at least one processor.

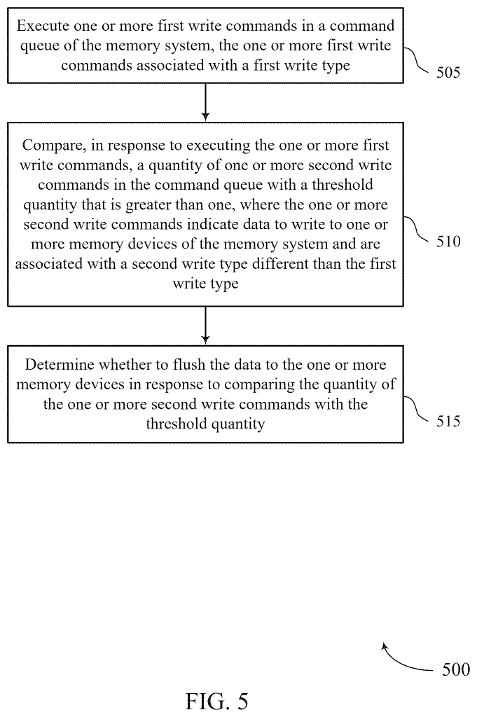

FIG. 5 shows a flowchart illustrating a method 500 that supports improved data flush for FUA commands in accordance with examples as disclosed herein. The operations of method 500 may be implemented by a memory system or its components as described herein. For example, the operations of method 500 may be performed by a memory system as described with reference to FIGS. 1 through 4. In some examples, a memory system may execute a set of instructions to control the functional elements of the device to perform the described functions. Additionally, or alternatively, the memory system may perform aspects of the described functions using special-purpose hardware.

At 505, the method may include executing one or more first write commands in a command queue of the memory system, the one or more first write commands associated with a first write type. In some examples, aspects of the operations of 505 may be performed by a write command component 425 as described with reference to FIG. 4.

At 510, the method may include comparing, in response to executing the one or more first write commands, a quantity of one or more second write commands in the command queue with a threshold quantity that is greater than one, where the one or more second write commands indicate data to write to one or more memory devices of the memory system and are associated with a second write type different than the first write type. In some examples, aspects of the operations of 510 may be performed by a command count comparison component 430 as described with reference to FIG. 4.

At 515, the method may include determining whether to flush the data to the one or more memory devices in response to comparing the quantity of the one or more second write commands with the threshold quantity. In some examples, aspects of the operations of 515 may be performed by a data flush component 435 as described with reference to FIG. 4.

In some examples, an apparatus as described herein may perform a method or methods, such as the method 500. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for executing one or more first write commands in a command queue of the memory system, the one or more first write commands associated with a first write type; comparing, in response to executing the one or more first write commands, a quantity of one or more second write commands in the command queue with a threshold quantity that is greater than one, where the one or more second write commands indicate data to write to one or more memory devices of the memory system and are associated with a second write type different than the first write type; and determining whether to flush the data to the one or more memory devices in response to comparing the quantity of the one or more second write commands with the threshold quantity.

Aspect 2: The method, apparatus, or non-transitory computer-readable medium of aspect 1, further including operations, features, circuitry, logic, means, or instructions, or any combination thereof for flushing the data to the one or more memory devices in accordance with the quantity of the one or more second write commands being greater than or equal to the threshold quantity and transmitting, to a host system coupled with the memory system, a response in accordance with flushing the data to the one or more memory devices.

Aspect 3: The method, apparatus, or non-transitory computer-readable medium of any of aspects 1 through 2, further including operations, features, circuitry, logic, means, or instructions, or any combination thereof for performing, in accordance with the quantity of the one or more second write commands being less than the threshold quantity, one or more command count comparisons, where determining whether to flush the data to the one or more memory devices is further in accordance with the one or more command count comparisons.

Aspect 4: The method, apparatus, or non-transitory computer-readable medium of aspect 3, further including operations, features, circuitry, logic, means, or instructions, or any combination thereof for determining whether a second time at which performance of the one or more command count comparisons is complete is within a threshold time period of a first time at which the performance of the one or more command count comparisons is initiated and flushing the data to the one or more memory devices in response to determining that the second time is not within the threshold time period.

Aspect 5: The method, apparatus, or non-transitory computer-readable medium of any of aspects 3 through 4, where performing the one or more command count comparisons includes operations, features, circuitry, logic, means, or instructions, or any combination thereof for comparing, at a first time, a second quantity of one or more pending write operations with the threshold quantity, the second quantity of one or more pending write operations including one or more write operations that are being executed by the memory system; comparing, at a second time that is after the first time, a sum of the second quantity of one or more pending write operations and the quantity of the one or more second write commands with the threshold quantity; and executing, at a third time, one or more third write commands of the first write type that are in the command queue, where executing the one or more third write commands is in accordance with the second quantity being greater than the threshold quantity or is in accordance with the sum being less than or equal to the threshold quantity or both, and where a duration between the first time and the third time includes a delay in accordance with the one or more command count comparisons.

Aspect 6: The method, apparatus, or non-transitory computer-readable medium of any of aspects 3 through 5, where performing the one or more command count comparisons includes operations, features, circuitry, logic, means, or instructions, or any combination thereof for comparing, in accordance with a second quantity of one or more pending write operations being less than the threshold quantity and in accordance with a sum of the second quantity of one or more pending write operations and the quantity of the one or more second write commands being less than or equal to the threshold quantity, the quantity of the one or more second write commands with a most recent quantity of one or more commands flushed to the one or more memory devices in a previous flush cycle of the memory system and determining whether to generate a delay in response to comparing the quantity of the one or more second write commands with the most recent quantity of one or more commands flushed to the one or more memory devices in the previous flush cycle of the memory system.

Aspect 7: The method, apparatus, or non-transitory computer-readable medium of aspect 6, further including operations, features, circuitry, logic, means, or instructions, or any combination thereof for generating the delay in accordance with the quantity of the one or more second write commands being less than the most recent quantity of one or more commands flushed to the one or more memory devices, where generating the delay extends a duration for performing the one or more command count comparisons.

Aspect 8: The method, apparatus, or non-transitory computer-readable medium of any of aspects 1 through 7, where flushing the data includes operations, features, circuitry, logic, means, or instructions, or any combination thereof for writing a first portion of the data to a first plane of each memory die of a plurality of memory dies of the memory system and writing, after writing to the first plane in every memory die of the plurality of memory dies, a second portion of the data to a second plane of each memory die of the plurality of memory dies.

Aspect 9: The method, apparatus, or non-transitory computer-readable medium of aspect 8, where flushing the data includes operations, features, circuitry, logic, means, or instructions, or any combination thereof for writing, before writing the first portion of the data to the first plane, a third portion of the data sequentially across a subset of one or more planes of one or more first memory dies of the plurality of memory dies and switching from a sequential write mode to a jump write mode in response to completing a write of the third portion of the data to a final plane of a final memory die in a first page line across the plurality of memory dies, where each page line of one or more page lines of the memory system includes one or more pages of memory across each plane of each memory die of the plurality of memory dies, where the first plane includes a beginning of the one or more page lines, and where writing the first portion of the data to the first plane of each memory die is in accordance with switching to the jump write mode.

Aspect 10: The method, apparatus, or non-transitory computer-readable medium of any of aspects 8 through 9, where flushing the data includes operations, features, circuitry, logic, means, or instructions, or any combination thereof for switching from a jump write mode associated with writing the first portion of the data and the second portion of the data to a sequential write mode in response to completing a write of the second portion of the data to the second plane in each memory die of the plurality of memory dies, where the second plane includes a final plane of a final memory die in a page line across the plurality of memory dies.

Aspect 11: The method, apparatus, or non-transitory computer-readable medium of any of aspects 1 through 10, where the threshold quantity is in accordance with a page size associated with the one or more memory devices.

Aspect 12: The method, apparatus, or non-transitory computer-readable medium of any of aspects 1 through 11, where the first write type includes a non-FUA write type and the second write type includes an FUA write type.

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit in accordance with the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed, and a second condition or action may at least partially occur as a result of the previous condition or action occurring (whether directly after or after one or more other intermediate conditions or actions occurring after the first condition or action).

Additionally, the terms “directly in response to” or “in direct response to” may refer to one condition or action occurring as a direct result of a previous condition or action. In some examples, a first condition or action may be performed, and a second condition or action may occur directly as a result of the previous condition or action occurring independent of whether other conditions or actions occur. In some examples, a first condition or action may be performed, and a second condition or action may occur directly as a result of the previous condition or action occurring, such that no other intermediate conditions or actions occur between the earlier condition or action and the second condition or action or a limited quantity of one or more intermediate steps or actions occur between the earlier condition or action and the second condition or action. Any condition or action described herein as being performed “based on,” “based at least in part on,” or “in response to” some other step, action, event, or condition may additionally, or alternatively (e.g., in an alternative example), be performed “in direct response to” or “directly in response to” such other condition or action unless otherwise specified.

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorus, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off” or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processing system (e.g., one or more processors, one or more controllers, control circuitry, processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A memory system, comprising:
one or more memory devices; and
processing circuitry coupled with the one or more memory devices and configured to cause the memory system to:
execute one or more first write commands in a command queue of the memory system, the one or more first write commands associated with a first write type;
compare, in response to executing the one or more first write commands, a quantity of one or more second write commands in the command queue with a threshold quantity that is greater than one, wherein the one or more second write commands indicate data to write to one or more memory devices of the memory system and are associated with a second write type different than the first write type; and
determine whether to flush the data to the one or more memory devices in response to comparing the quantity of the one or more second write commands with the threshold quantity.

2. The memory system of claim 1, wherein the processing circuitry is further configured to cause the memory system to:
flush the data to the one or more memory devices in accordance with the quantity of the one or more second write commands being greater than or equal to the threshold quantity; and
transmit, to a host system coupled with the memory system, a response in accordance with flushing the data to the one or more memory devices.

3. The memory system of claim 1, wherein the processing circuitry is further configured to cause the memory system to:
perform, in accordance with the quantity of the one or more second write commands being less than the threshold quantity, one or more command count comparisons, wherein determining whether to flush the data to the one or more memory devices is further in accordance with the one or more command count comparisons.

4. The memory system of claim 3, wherein the processing circuitry is further configured to cause the memory system to:
determine whether a second time at which performance of the one or more command count comparisons is complete is within a threshold time period of a first time at which the performance of the one or more command count comparisons is initiated; and
flush the data to the one or more memory devices in response to determining that the second time is not within the threshold time period.

5. The memory system of claim 3, wherein performing the one or more command count comparisons comprises the processing circuitry configured to cause the memory system to:
compare, at a first time, a second quantity of one or more pending write operations with the threshold quantity, the second quantity of one or more pending write operations comprising one or more write operations that are being executed by the memory system;
compare, at a second time that is after the first time, a sum of the second quantity of one or more pending write operations and the quantity of the one or more second write commands with the threshold quantity; and
execute, at a third time, one or more third write commands of the first write type that are in the command queue, wherein executing the one or more third write commands is in accordance with the second quantity being greater than the threshold quantity or is in accordance with the sum being less than or equal to the threshold quantity or both, and wherein a duration between the first time and the third time comprises a delay in accordance with the one or more command count comparisons.

6. The memory system of claim 3, wherein performing the one or more command count comparisons comprises the processing circuitry configured to cause the memory system to:
compare, in accordance with a second quantity of one or more pending write operations being less than the threshold quantity and in accordance with a sum of the second quantity of one or more pending write operations and the quantity of the one or more second write commands being less than or equal to the threshold quantity, the quantity of the one or more second write commands with a most recent quantity of one or more commands flushed to the one or more memory devices in a previous flush cycle of the memory system; and
determine whether to generate a delay in response to comparing the quantity of the one or more second write commands with the most recent quantity of one or more commands flushed to the one or more memory devices in the previous flush cycle of the memory system.

7. The memory system of claim 6, wherein the processing circuitry is further configured to cause the memory system to:
generate the delay in accordance with the quantity of the one or more second write commands being less than the most recent quantity of one or more commands flushed to the one or more memory devices, wherein generating the delay extends a duration for performing the one or more command count comparisons.

8. The memory system of claim 1, wherein flushing the data comprises the processing circuitry configured to cause the memory system to:
write a first portion of the data to a first plane of each memory die of a plurality of memory dies of the memory system; and
write, after writing to the first plane in every memory die of the plurality of memory dies, a second portion of the data to a second plane of each memory die of the plurality of memory dies.

9. The memory system of claim 8, wherein flushing the data comprises the processing circuitry configured to cause the memory system to:
write, before writing the first portion of the data to the first plane, a third portion of the data sequentially across a subset of one or more planes of one or more first memory dies of the plurality of memory dies; and
switch from a sequential write mode to a jump write mode in response to completing a write of the third portion of the data to a final plane of a final memory die in a first page line across the plurality of memory dies, wherein each page line of one or more page lines of the memory system comprises one or more pages of memory across each plane of each memory die of the plurality of memory dies, wherein the first plane comprises a beginning of the one or more page lines, and wherein writing the first portion of the data to the first plane of each memory die is in accordance with switching to the jump write mode.

10. The memory system of claim 8, wherein flushing the data comprises the processing circuitry configured to cause the memory system to:
switch from a jump write mode associated with writing the first portion of the data and the second portion of the data to a sequential write mode in response to completing a write of the second portion of the data to the second plane in each memory die of the plurality of memory dies, wherein the second plane comprises a final plane of a final memory die in a page line across the plurality of memory dies.

11. The memory system of claim 1, wherein the threshold quantity is in accordance with a page size associated with the one or more memory devices.

12. The memory system of claim 1, wherein the first write type comprises a non-force unit access (FUA) write type and the second write type comprises an FUA write type.

13. A non-transitory computer-readable medium storing code, the code comprising instructions executable by one or more processors to:
execute one or more first write commands in a command queue of a memory system, the one or more first write commands associated with a first write type;
compare, in response to executing the one or more first write commands, a quantity of one or more second write commands in the command queue with a threshold quantity that is greater than one, wherein the one or more second write commands indicate data to write to one or more memory devices of the memory system and are associated with a second write type different than the first write type; and
determine whether to flush the data to the one or more memory devices in response to comparing the quantity of the one or more second write commands with the threshold quantity.

14. The non-transitory computer-readable medium of claim 13, wherein the instructions are further executable by the one or more processors to:
flush the data to the one or more memory devices in accordance with the quantity of the one or more second write commands being greater than or equal to the threshold quantity; and
transmit, to a host system coupled with the memory system, a response in accordance with flushing the data to the one or more memory devices.

15. The non-transitory computer-readable medium of claim 13, wherein the instructions are further executable by the one or more processors to:
perform, in accordance with the quantity of the one or more second write commands being less than the threshold quantity, one or more command count comparisons, wherein determining whether to flush the data to the one or more memory devices is further in accordance with the one or more command count comparisons.

16. The non-transitory computer-readable medium of claim 15, wherein the instructions are further executable by the one or more processors to:
determine whether a second time at which performance of the one or more command count comparisons is complete is within a threshold time period of a first time at which the performance of the one or more command count comparisons is initiated; and
flush the data to the one or more memory devices in response to determining that the second time is not within the threshold time period.

17. The non-transitory computer-readable medium of claim 15, wherein the instructions to perform the one or more command count comparisons are executable by the one or more processors to:
compare, at a first time, a second quantity of one or more pending write operations with the threshold quantity, the second quantity of one or more pending write operations comprising one or more write operations that are being executed by the memory system;
compare, at a second time that is after the first time, a sum of the second quantity of one or more pending write operations and the quantity of the one or more second write commands with the threshold quantity; and
execute, at a third time, one or more third write commands of the first write type that are in the command queue, wherein executing the one or more third write commands is in accordance with the second quantity being greater than the threshold quantity or is in accordance with the sum being less than or equal to the threshold quantity or both, and wherein a duration between the first time and the third time comprises a delay in accordance with the one or more command count comparisons.

18. The non-transitory computer-readable medium of claim 15, wherein the instructions to perform the one or more command count comparisons are executable by the one or more processors to:
compare, in accordance with a second quantity of one or more pending write operations being less than the threshold quantity and in accordance with a sum of the second quantity of one or more pending write operations and the quantity of the one or more second write commands being less than or equal to the threshold quantity, the quantity of the one or more second write commands with a most recent quantity of one or more commands flushed to the one or more memory devices in a previous flush cycle of the memory system; and
determine whether to generate a delay in response to comparing the quantity of the one or more second write commands with the most recent quantity of one or more commands flushed to the one or more memory devices in the previous flush cycle of the memory system.

19. The non-transitory computer-readable medium of claim 18, wherein the instructions are further executable by the one or more processors to:
generate the delay in accordance with the quantity of the one or more second write commands being less than the most recent quantity of one or more commands flushed to the one or more memory devices, wherein generating the delay extends a duration for performing the one or more command count comparisons.

20. The non-transitory computer-readable medium of claim 13, wherein the instructions to flush the data are executable by the one or more processors to:
write a first portion of the data to a first plane of each memory die of a plurality of memory dies of the memory system; and
write, after writing to the first plane in every memory die of the plurality of memory dies, a second portion of the data to a second plane of each memory die of the plurality of memory dies.

21. The non-transitory computer-readable medium of claim 20, wherein the instructions to flush the data are executable by the one or more processors to:
write, before writing the first portion of the data to the first plane, a third portion of the data sequentially across a subset of one or more planes of one or more first memory dies of the plurality of memory dies; and
switch from a sequential write mode to a jump write mode in response to completing a write of the third portion of the data to a final plane of a final memory die in a first page line across the plurality of memory dies, wherein each page line of one or more page lines of the memory system comprises one or more pages of memory across each plane of each memory die of the plurality of memory dies, wherein the first plane comprises a beginning of the one or more page lines, and wherein writing the first portion of the data to the first plane of each memory die is in accordance with switching to the jump write mode.

22. The non-transitory computer-readable medium of claim 20, wherein the instructions to flush the data are executable by the one or more processors to:
switch from a jump write mode associated with writing the first portion of the data and the second portion of the data to a sequential write mode in response to completing a write of the second portion of the data to the second plane in each memory die of the plurality of memory dies, wherein the second plane comprises a final plane of a final memory die in a page line across the plurality of memory dies.

23. The non-transitory computer-readable medium of claim 13, wherein the threshold quantity is in accordance with a page size associated with the one or more memory devices.

24. The non-transitory computer-readable medium of claim 13, wherein the first write type comprises a non-force unit access (FUA) write type and the second write type comprises an FUA write type.

25. A method by a memory system, comprising:
executing one or more first write commands in a command queue of the memory system, the one or more first write commands associated with a first write type;
comparing, in response to executing the one or more first write commands, a quantity of one or more second write commands in the command queue with a threshold quantity that is greater than one, wherein the one or more second write commands indicate data to write to one or more memory devices of the memory system and are associated with a second write type different than the first write type; and
determining whether to flush the data to the one or more memory devices in response to comparing the quantity of the one or more second write commands with the threshold quantity.
